(19) United States
(12) Patent Application Publication
(10) Pub. No.: US 2006/0126488 A1
(43) Pub. Date: Jun. 15, 2006

(54) Broadcast receiving apparatus and method for controlling video switch thereof

(75) Inventor: Min-gu Kang, Gyeonggi-do (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/296,411

(22) Filed: Dec. 8, 2005

(30) Foreign Application Priority Data
Dec. 14, 2004 (KR) 2004-105670

(51) Int. Cl. H04J 11/00

(52) U.S. Cl. 370/206

(57) ABSTRACT

A broadcast receiving apparatus and a method for controlling a video switch of the broadcast receiving apparatus. Upon receiving a channel select signal instructing to change from a first broadcast channel currently viewed to a second broadcast channel, an entire pre-stored video stream of the first broadcast channel is decoded and displayed and then the video mute is executed. Accordingly, the present invention gives the impression that the channel is quickly switched by reducing the video mute time by a VBV buffer delay time, which is required due to the broadcast channel change.

### CROSS-REFERENCE TO RELATED APPLICATIONS

This application claims priority from Korean Patent Application No. 2004-105670 filed on Dec. 14, 2004 in the Korean Intellectual Property Office, the entire disclosure of which is incorporated herein by reference.

### BACKGROUND OF THE INVENTION

1. Field of The Invention

Methods and apparatuses consistent with the present invention relate generally to a broadcast receiving apparatus and a method for controlling a video switch of the broadcast receiving apparatus, and more particularly, to a broadcast receiving apparatus and a method for controlling a video switch of the broadcast receiving apparatus to reduce a video mute that occurs when a channel is changed.

2. Description of The Related Art

Digital TVs receive a broadcast signal of an intended broadcast channel, converts the broadcast signal to a transport stream, separates a video stream from the converted transport stream, and processes a Moving Picture Experts Group (MPEG) decoding so as to display the video of the broadcast channel.

In respect of the video switch according to a change of the broadcast channel, the digital TV's function is quite slower than analog TVs, which causes a number of viewers to feel inconvenience due to a long video mute time. The video mute displays a black screen on a display section of a broadcast receiver because a broadcast signal is not received from broadcast channels.

FIG. 1 is a flowchart explaining how the video is switched at a conventional broadcast receiver.

Referring to FIG. 1, while the conventional broadcast receiver decodes a video stream of a current broadcast channel (hereinafter, referred to as a first broadcast channel) and displays a video of the first broadcast channel, if a new broadcast channel (hereinafter, referred to as a second broadcast channel) is selected (S110), the conventional broadcast receiver aborts immediately the display of the first broadcast channel video and displays only a black screen by executing a video mute function (S120). Next, the broadcast receiver tunes to the second broadcast channel newly selected with the video mute function executed (S130). The broadcast receiver decodes a video stream of the second broadcast channel (S140), and releases the video mute function so as to display the video of the second broadcast channel on the screen (S150).

FIG. 2 is diagram of the video mute time according to the video switch of the conventional broadcast receiver. In FIG. 2, a time T₁ is when the second broadcast channel is selected and the video mute is executed, and a time T₂ is when the video mute is released and the video of the second broadcast channel is displayed on the screen. Accordingly, when the broadcast channel is changed, the screen is stopped for the time T₂−T₁ at the conventional broadcast receiver. Because it is a very short time from when the second broadcast channel is selected until the video mute is executed, the input of the select signal of the second broadcast channel and the execution of the video mute can be regarded as occurring substantially concurrently at the time T₁.

### SUMMARY OF THE INVENTION

An aspect of the present invention provides a broadcast receiving apparatus and a method for controlling a video switch at a broadcast receiving apparatus to reduce a video mute time occurring when a channel is changed. An exemplary embodiment of the present invention includes a broadcast receiving apparatus having a channel selector for receiving a selection of a broadcast channel among a plurality of broadcast channels; and a controller for controlling to execute a video mute after decoding and displaying on a screen an entire video stream of a first broadcast channel being pre-stored, upon receiving a channel select signal instructing to change from the first broadcast channel that is currently displayed to a second broadcast channel.

The broadcast receiving apparatus may further include a broadcast receiver for receiving a broadcast signal of the selected broadcast channel and converting the received broadcast signal to a transport stream; a demultiplexer for separating a video stream, an audio stream, and a broadcast information stream from the transport stream converted at the broadcast receiver; a buffer for storing the video stream separated at the demultiplexer; a video decoder for decoding the video stream stored at the buffer, and an image processor for converting the video stream output from the video decoder to video data of a display format.

The broadcast receiving apparatus may further include a display for displaying a video corresponding to the video data output from the image processor.

The broadcast receiver may include a tuner for tuning to the broadcast channel selected through the channel selector, and a demodulator for converting the broadcast signal of the tuned broadcast channel to the transport stream.

In an exemplary embodiment, the demodulator may be one of a vestigial sideband (VSB) demodulator, a quadrature amplitude modulation (QAM) demodulator, and a VBS/QAM demodulator. The broadcast information stream contains VBV delay time information of the broadcast signal. The controller may control to release the video mute by decoding a video stream of the second broadcast channel stored at the buffer after the VBV delay time and displaying the video stream at the display.

Consistent with the above aspects of the present invention, a video switch method of a broadcast receiving apparatus, according to an exemplary embodiment of the present invention, includes the operations of receiving a channel select signal instructing to change from a first broadcast channel, which is currently displayed, to a second broadcast channel; and executing a video mute after decoding and displaying entire pre-stored video stream of the first broadcast channel upon receiving the channel select signal.

The video switch method may further include the operation of tuning to the second broadcast channel when the channel select signal is input. The tuning to the second broadcast channel may precede the execution of the video mute.

The video switch method may further include the operations of receiving a broadcast signal of the tuned second broadcast channel and converting the broadcast signal to a transport stream; separating a video stream, an audio stream, and a broadcast information stream from the converted transport stream; storing the separated video stream; decoding and outputting the stored video stream after a predetermined time; and displaying a video corresponding to the decoded video stream. The predetermined time is a video buffer verifier (VBV) delay time contained in the broadcast information stream.

### BRIEF DESCRIPTION OF THE DRAWING FIGURES

These and/or other aspects of the invention will become apparent and more readily appreciated from the following description of exemplary embodiments, taken in conjunction with the accompanying drawing figures of which:

FIG. 1 is a flowchart explaining a video switch method of a conventional broadcast receiver;

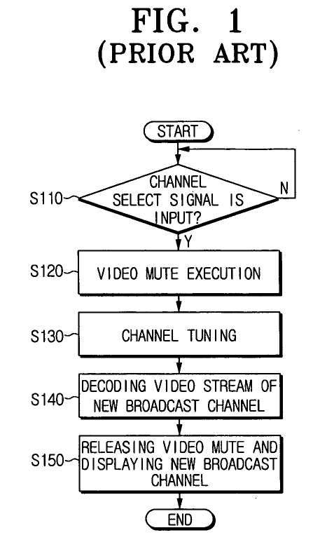

FIG. 2 is a diagram illustrating a video mute time of the conventional broadcast receiver;

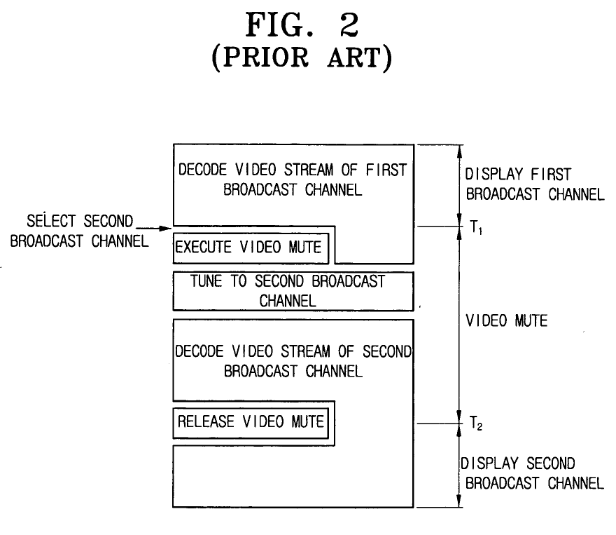

FIG. 3 is a block diagram of a broadcast receiving apparatus according to an exemplary embodiment of the present invention;

FIG. 4 is a flowchart explaining a video switch method of the broadcast receiving apparatus of FIG. 3; and

FIG. 5 is a diagram illustrating a video mute time according to an exemplary embodiment of the present invention.

### DETAILED DESCRIPTION OF EXEMPLARY EMBODIMENTS OF THE INVENTION

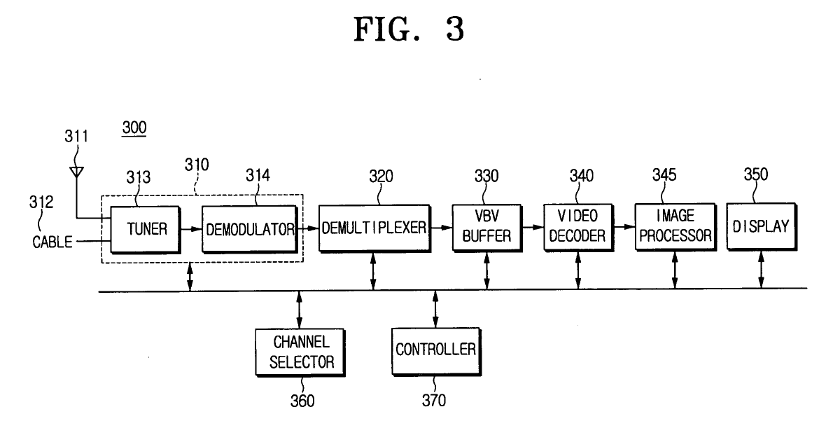

Reference will now be made in detail to exemplary embodiments of the present invention, examples of which are illustrated in the accompanying drawings, wherein like reference numerals refer to the like elements throughout. The embodiments are described below to explain the present invention by referring to the figures. FIG. 3 is a block diagram of a broadcast receiving apparatus according to an exemplary embodiment of the present invention.

Referring now to FIG. 3, the broadcast receiving apparatus 300 includes a broadcast receiver 310, a demultiplexer 320, a video buffering verifier (VBV) buffer 330, a video decoder 340, a display 350, a channel selector 360, and a controller 370. The broadcast receiver 310 includes a tuner 313 and a demodulator 314.

The broadcast receiver 310 receives a broadcast signal of a broadcast channel, selected from the channel selector 360, among a plurality of broadcast channels input from an external source, and converts the received broadcast channel to a transport stream. The broadcast receiver 310 includes the tuner 313 for tuning to the selected broadcast channel, and the demodulator 314 for converting the broadcast signal of the tuned broadcast channel to a transport stream. The demodulator 314 can be realized using a vestigial sideband (VSB) demodulator when the broadcast signal is received via an antenna 311 by radio, or using a quadrature amplitude modulation (QAM) demodulator when the broadcast signal is received through a cable 312. Also, the demodulator 314 may be realized using a VSB/QAM demodulator.

The demultiplexer 320 separates a video stream, an audio stream, and a broadcast information stream from the transport stream converted at the broadcast receiver 310, and transfers the separated streams to relevant decoders. In particular, the video stream is transferred to the video decoder 340, and the broadcast information stream is transferred to the controller 370 via a broadcast information decoder (not shown).

The VBV buffer 330 temporarily stores the video stream output from the demultiplexer 320, and provides the buffered video stream to the video decoder 340 after a VBV buffer delay time. According to the Moving Picture Experts Group (MPEG)-2 standard, MPEG decoding (hereinafter, referred to as a decoding) is conducted to the video stream stored at the VBV buffer 330 after a predetermined time. This is because an incomplete video may be displayed if the video stream is decoded right after the inputting. The VBV buffer delay time is the duration from the storing of the video stream at the VBV buffer 330 to the decoding of the stored video stream. The VBV buffer 330 stores data of the video stream corresponding to a maximum of 500 milliseconds, for example. Information relating to the VBV buffer delay time is contained in the broadcast information stream.

Since the VBV buffer 330 pre-stores the video stream, that will be decoded in the VBV buffer delay time prior to the video stream in process of the decoding, the broadcast receiving apparatus 300 may not execute the video mute even when a new channel is selected. The broadcast receiving apparatus 300 continues to decode the pre-stored video stream of the broadcast channel before the channel change for the VBV buffer delay time and displays the decoded video stream on a screen.

The video decoder 340 conducts the MPEG decoding with respect to the video stream stored at the VBV buffer 330 after the VBV buffer delay time, and outputs the decoded video stream to an image processor 345. The image processor 345 converts the video stream output from the video decoder 340, to video data of a display format which is displayable at a display 350. The display 350 displays a video corresponding to the video data output from the image processor 345.

The channel selector 360 is provided with manipulation keys such as numeric keys, direction keys, and function keys so as to receive the selection of the broadcast channel to be viewed by the user. The broadcast channel may be input through a remote controller from the user.

The controller 370 controls the overall operation of the broadcast receiving apparatus 300. In an exemplary embodiment of the present invention, when a channel select signal for a new broadcast channel is input through the channel selector 360 while the current broadcast channel is displayed, the entire video stream of the current broadcast channel, which is pre-stored at the VBV buffer 330, is decoded and displayed on the screen. Next, the video mute is executed by blocking the video signal input to the display 350. The controller 370, before executing the video mute, controls the tuner 313 to tune to the new broadcast channel. The controller 370 controls the video decoder 340 to decode the video stream of the new broadcast channel which is stored at the VBV buffer 330 after the VBV buffer delay time and to output the decoded video stream to the display 350, thus releasing the video mute.

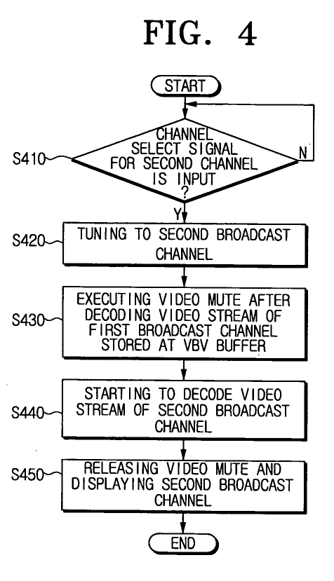

FIG. 4 is a flowchart explaining of a video switch method of the broadcast receiving apparatus according to an exemplary embodiment of the present invention.

Referring to FIG. 3 and FIG. 4, while the controller 370 controls to decode the video stream of the current broadcast channel (hereinafter, referred to as a first broadcast channel) and to display the video of the first broadcast channel on the screen, if the channel select signal for a new channel (hereinafter, referred to as a second broadcast channel) is input (S410), the controller 370 controls to display the video of the first broadcast channel by continuously decoding the video stream of the first broadcast channel which is pre-stored at the VBV buffer 330, and controls the tuner 313 to tune to the second broadcast channel (S420).

Upon completing the decoding of the video stream of the first broadcast channel being pre-stored at the VBV buffer 330, the controller 370 executes the video mute to block the video signal input to the display 350 and displays the black screen at the display 350 (S430).

The controller 370 controls the video decoder 340 to start to decode the video stream of the second broadcast channel being stored at the VBV buffer 330 after the VBV buffer delay time (S440). When the video stream of the second broadcast channel, which is converted to the video data of the display format being displayable at the display 350, is input to the display 350, the controller 370 controls to release the video mute and to display the video of the second broadcast channel (S450).

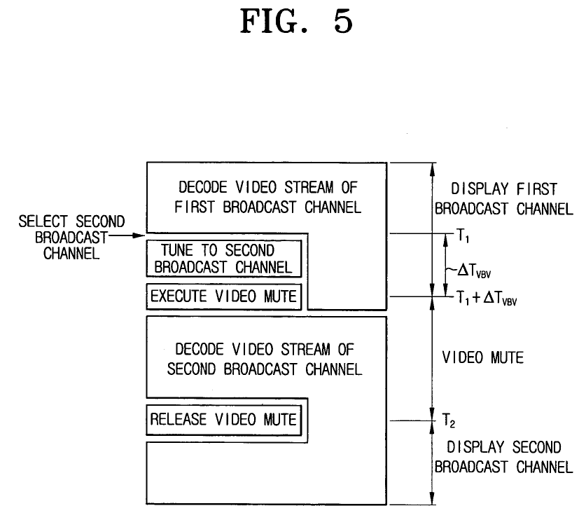

FIG. 5 is a diagram illustrating a video mute time according to an exemplary embodiment of the present invention.

In FIG. 5, a time T₁ is when the second broadcast channel is selected, a time T₁+ΔT_{VBV} is when the video mute is executed after decoding and displaying the entire video stream of the first broadcast channel pre-stored at the VBV buffer 330, and a time T₂ is when the video mute is released and the video of the second broadcast channel is displayed on the screen. ΔT_{VBV} indicates the VBV buffer delay time. Accordingly, it takes T₂−T₁ from the selection of the second broadcast channel until the video display of the second broadcast channel, which equals the time taken according to the related art. However, rather than executing the video mute right after selecting the second broadcast channel, the video of the first broadcast channel is continuously displayed on the screen for the VBV buffer delay time ΔT_{VBV}. As a result, the video mute time is shortened by ΔT_{VBV} (T₂−T₁−ΔT_{VBV}) as compared with the related art.

In light of the foregoing as set forth, the present invention enables the user to experience a fast channel switch by reducing the video mute time by the VBV buffer delay time, which is required due to the broadcast channel change.

Although exemplary embodiments of the present invention have been shown and described, it would be appreciated by those skilled in the art that changes may be made in these exemplary embodiments without departing from the principles and spirit of the invention, the scope of which is defined in the claims and their equivalents.

What is claimed is:

1. A broadcast receiving apparatus comprising:
a channel selector which selects a broadcast channel from among a plurality of broadcast channels; and
a controller which receives a channel select signal from the channel selector and executes a video mute operation after decoding and displaying on a screen an entire pre-stored video stream of a first broadcast channel, upon receiving the channel select signal which instructs to change from the first broadcast channel that is currently displayed to a second broadcast channel.

2. The broadcast receiving apparatus of claim 1, further comprising:
a broadcast receiver which receives a broadcast signal of the broadcast channel which is selected and converts the received broadcast signal to a trasport stream;
a demultiplexer which separates a video stream, an audio stream, and a broadcast information stream from the transport stream;
a buffer which stores the video stream separated at the demultiplexer;
a video decoder which decodes the video stream stored at the buffer; and
an image processor which converts the video stream, which is decoded by and output from the video decoder, to video data of a display format.

3. The broadcast receiving apparatus of claim 2, further comprising:
a display which displays a video corresponding to the video data which is output from the image processor.

4. The broadcast receiving apparatus of claim 2, wherein the broadcast receiver comprises:
a tuner which tunes to the broadcast channel selected through the channel selector; and
a demodulator which converts the broadcast signal of the broadcast channel, which is tuned, to the transport stream.

5. The broadcast receiving apparatus of claim 4, wherein the demodulator is one of a vestigial sideband (VSB) demodulator, a quadrature amplitude modulation (QAM) demodulator, and a VBS/QAM demodulator.

6. The broadcast receiving apparatus of claim 2, wherein the buffer is a video buffer verifier (VBV) buffer.

7. The broadcast receiving apparatus of claim 2, wherein the broadcast information stream contains video buffer verifier (VBV) delay time information of the broadcast signal.

8. The broadcast receiving apparatus of claim 7, wherein the controller controls to release the video mute by decoding a video stream of the second broadcast channel stored at the buffer after the VBV delay time and displays the video stream at the display.

9. A video switch method of a broadcast receiving apparatus, the method comprising:
receiving a channel select signal instructing to change from a first broadcast channel, which is currently displayed, to a second broadcast channel; and
executing a video mute operation after decoding and displaying an entire pre-stored video stream of the first broadcast channel upon receiving the channel select signal.

10. The video switch method of claim 9, further comprising tuning to the second broadcast channel when the channel select signal is input, wherein the tuning to the second broadcast channel precedes the execution of the video mute.

11. The video switch method of claim 10, further comprising:
receiving a broadcast signal of the second broadcast channel which is tuned and converting the broadcast signal to a transport stream;
separating a video stream, an audio stream, and a broadcast information stream from the transport stream;
storing the video stream which is separated;
decoding and outputting the video stream, which is stored, after a predetermined time; and
displaying a video corresponding to the video stream which is decoded.

12. The video switch method of claim 11, wherein the predetermined time is a video buffer verifier (VBV) delay time contained in the broadcast information stream.
